(19) United States
(12) Patent Application Publication
(10) Pub. No.: US 2004/0120010 A1
(43) Pub. Date: Jun. 24, 2004

(54) System and method for creating animated books

(75) Inventors: Maribeth Joy Back, San Francisco, CA (US); Matthew Grant Gorbet, Toronto (CA); Karen Marcelo, San Francisco, CA (US)

Correspondence Address: Gunnar G. Leinberg, Esq., Nixon Peabody LLP, Clinton Square, P.O. Box 31051, Rochester, NY, 14603-1051, US

(73) Assignee: Xerox Corporation

(21) Appl. No.: 10/324,654

(22) Filed: Dec. 18, 2002

(51) Int. Cl. G06K 15/02; G06F 3/12; G06F 13/00

(52) U.S. Cl. 358/1.18; 358/1.15; 270/58.08

(57) ABSTRACT

Method and system for creating animated books include one or more processors, memory, video capture controller, user input controller, audio input controller, display controller, audio output controller, vending unit, I/O interface and a book creation system. The method includes converting video data into at least two images, where each image represents a portion of the video data at an instant within a time interval, reproducing one of the images onto one of a plurality of sheets, reproducing another one of the images onto another one of the sheets, and binding the sheets together to create an animated book. Movement of a first bound sheet of the book in a first direction and away from a second bound sheet of the book creates an appearance of motion.

### FIELD

This invention relates generally to a system and method for information presentation and, more particularly, to a method and system for creating animated books.

### BACKGROUND

Photographs and postcards are often used by people to convey simple greetings and messages to friends and loved ones. Photographs are easy to take using a camera, and postcards can be purchased at a store and personalized by handwriting a message in the appropriate location. Animated books, such as flip books, can be used to display more complex expressions by simulating motion. These books have slightly altered images printed on each page such that when the pages are rapidly flipped the appearance of animation is created. One could manually make a flip book by attaching several pieces of paper together at one end and drawing on each succeeding page each instance of an object as it moves from a first location to a second location. While this process seems simple, it can also be tedious and time consuming. Shopping malls are often replete with booths for creating post cards or for taking photographs, but none have the capability to create animated books.

### SUMMARY

A system in accordance with embodiments of the present invention includes a converting system that converts video data into at least two images, where each image represents a portion of the video data at an instant within a time interval. A printing system reproduces one of the images onto one of a plurality of sheets. Further, the printing system reproduces another one of the images onto another one of the sheets, and a binding system binds a portion of each of the sheets together.

A method and a program storage device readable by a machine and tangibly embodying a program of instructions executable by the machine in accordance with embodiments of the present invention include converting video data into at least two images, each image representing a portion of the video data at an instant within a time interval, reproducing one of the images onto one of a plurality of sheets and another one of the images onto another one of the sheets, and binding a portion of each of the sheets together.

The present invention has a number of advantages, including providing a fun, creative, convenient and fast way to make gifts that can convey personal and complex messages. Moreover, the present invention provides an easy way to create personalized animated books without requiring users to have technical, creative or artistic expertise. Additionally, the invention provides users with an enjoyable experience while composing a professional quality animated message.

### BRIEF DESCRIPTION

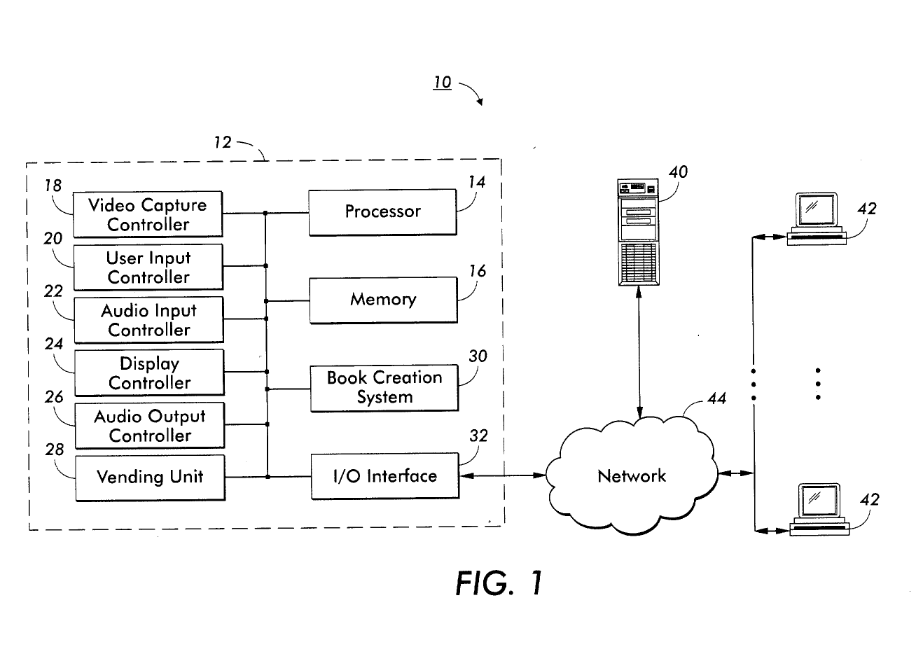

FIG. 1 is a block diagram of a system for creating animated books in accordance with embodiments of the present invention;

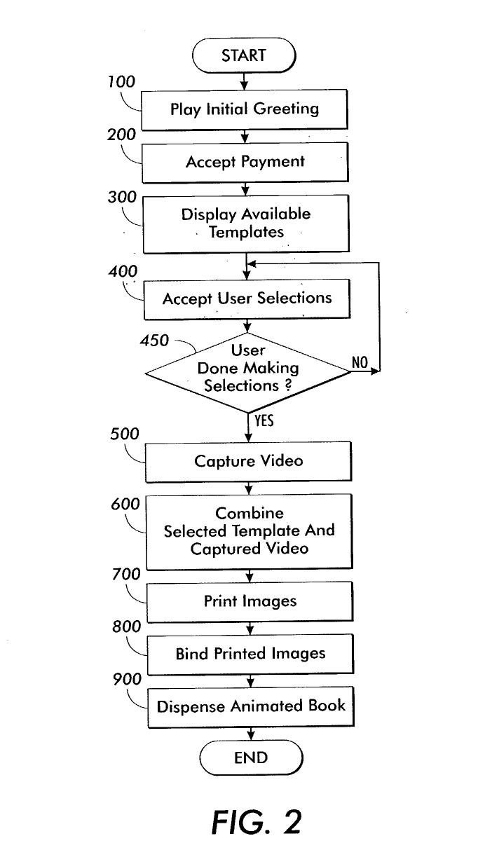

FIG. 2 is a flow chart of a process for creating animated books in accordance with embodiments of the present invention;

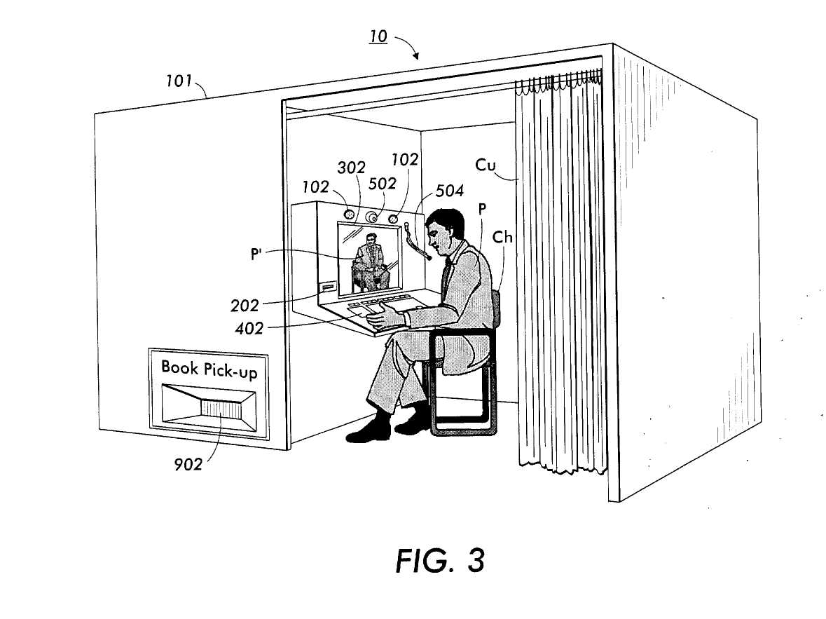

FIG. 3 is a perspective view of a booth used in a system for creating animated books in accordance with embodiments of the present invention;

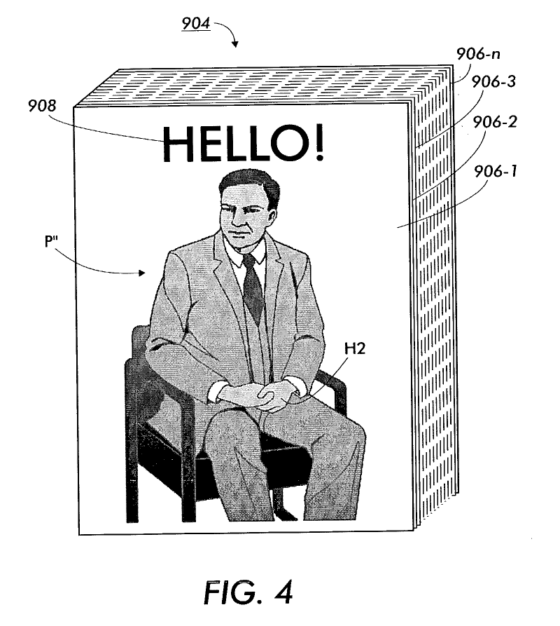

FIG. 4 is an animated book in accordance with embodiments of the present invention; and

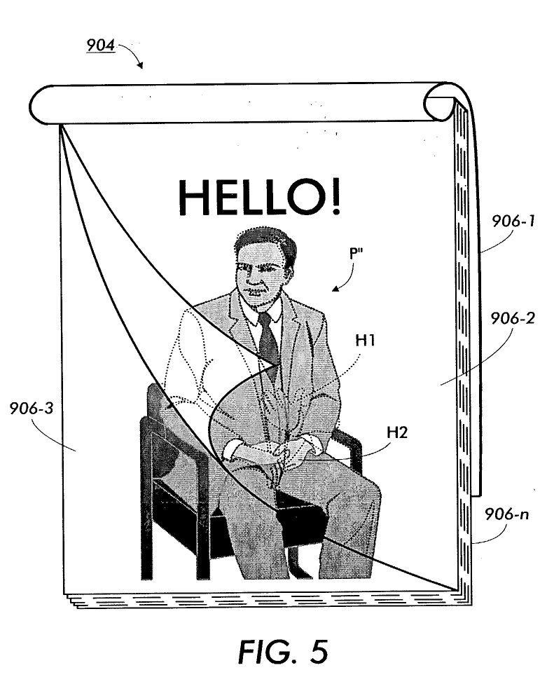

FIG. 5 is an animated book in motion in accordance with embodiments of the present invention.

### DETAILED DESCRIPTION

A system 10 for creating animated books in accordance with embodiments of the present invention is shown in FIG. 1. The system 10 includes animated book creation device 12 having a processor 14, memory 16, video capture controller 18, user input controller 20, audio input controller 22, display controller 24, audio output controller 26, vending unit 28, book creation system 30 and I/O interface 32, which are coupled together by one or more buses, although other coupling techniques may be used. The system 10 has a number of advantages, including providing a fun, creative, convenient and fast way to make gifts that can convey personal and complex messages. Moreover, the system 10 provides an easy way to create personalized animated books 904 without requiring users to have technical, creative or artistic expertise. Additionally, the system 10 provides users with an enjoyable experience while composing a professional quality animated message.

In embodiments of the present invention, processor 14 comprises a central processing unit, such as an Intel Pentium III® processor, although other processors may be used, such as a PowerPC G4® or a picoJava I® processor, the particular type depending upon desired performance and size constraints of system 10. The processor 14 executes at least one program of instructions for a method of creating animated books stored in memory 16 as described and illustrated herein. Processor 14 may also execute instructions for other tasks, including network devices such as providing data, memory, file directories, individual files, word processing applications, accounting applications or engineering applications. As a result, when one of these applications is executed, the instructions for the task, such as for creating a spreadsheet, as well as the instructions for performing one or more of the methods of the present invention are executed by the processor 14. These instructions may be expressed as executable programs written in a number of computer programming languages, such as BASIC, Pascal, C, C++, C#, Java, Perl, COBOL, FORTRAN, assembly language, machine code language, or any computer code or language that can be understood and performed by the processor 14.

Memory 16 comprises a hard-disk computer-readable medium, although memory 16 may comprise any type of fixed or portable media accessible and readable by the device 12 (i.e., processor 14, controllers 18-26, etc.), such as a floppy-disk, compact-disc, digital-video disc, magnetic tape, optical disk, Ferroelectric memory, Ferro-magnetic memory, read-only memory, random access memory, electrically erasable programmable read-only memory, erasable programmable read-only memory, flash memory, static random access memory, dynamic random access memory, charge coupled devices, smart cards, a combination of one or more of the above, or any other type of computer-readable media. Memory 16 stores instructions and data for performing the present invention for execution by processor 14, although some or all of these instructions and data may be stored elsewhere, such as in a memory of server 40 or computers 42. Although the processor 14 and memory 16 are shown in the same physical location, they may be located in different physical locations, such as in server 40 or computers 42.

Video capture controller 18 comprises a micro-controller that processes images received by a device (e.g., video camera, high speed camera, etc.) to convert the received images into a file format appropriate for storage in memory 16 (e.g., jpg, gif, tif, etc.) and appropriate for further processing by the processor 14 as described further herein.

User input controller 20 comprises a micro-controller that detects and processes user input received through a device (e.g., keyboard, mouse, light pen, etc.), and communicates the received user input to the processor 14 for further processing as described further herein.

Audio input controller 22 comprises a micro-controller that processes audio received by a device (e.g., microphone) to convert the received audio into a file format appropriate for storage in memory 16 (e.g., .wav, .mp3, .mus, etc.), and for further processing by the processor 14 as described further herein. The audio input controller 22 may also process signals received from an audio signal source through the I/O interface 32 to convert them into the proper file format for memory 16 and processor 14, or it may send the audio files directly to the memory 16 for storage and further processing by the processor 16 in the event they are received in the proper format.

Display controller 24 comprises a micro-controller that communicates with the processor 14 to send image data to a video display device (e.g., television screen, LCD panel, monitor, etc.) that is to be displayed by the video display device. The display controller 24 may retrieve the image data from a number of sources, including directly from the video capture controller 18 or the video capture device (e.g., video camera), memory 16, the server 40, the computers 42, or from any video signal source accessible through the I/O interface 32.

Audio output controller 26 comprises a micro-controller that communicates with the processor 14 to send audio data to an audio output device (e.g., audio speaker, etc.) that is to be output by the audio device. The audio output controller 26 may retrieve the audio data from a number of sources, including from the server 40, the computers 42, or from any audio signal source accessible through the I/O interface 32.

Vending unit 28 comprises a payment system that provides an interface for allowing payment (e.g., monetary, credit card, etc.) to be accepted by the animated book creation device 12. Since vending systems are well known in the art, the specific elements, their arrangement within the vending system and basic operation will not be described in detail here. The vending unit communicates with the processor 14 to notify the processor 14 when an amount satisfying a minimum predetermined payment amount has been received by the vending unit 28.

Book creation system 30 comprises a book binding system that performs functions such as printing, cutting, trimming, gluing, covering and binding pages into flip or animated book form using technologies such as the Xerox® Book-In-Time™ technology, although “Just-In-Time” printing and binding systems may also be used. An example of the Xerox® Book-In-Time™ technology is described in the “JIT SOLUTIONS: XEROX BOOK IN TIME” Technical Brief, Xerox Corporation, 2000, which is incorporated herein by reference in its entirety. Since book binding systems are well known in the art, the specific elements, their arrangement within the book binding system and basic operation will not be described in detail here.

I/O interface 32 comprises one or more interfaces that connect the animated book creation device 12 to one or more servers 40 and one or more computers 42 by way of network 44, and enables the device 12 to send and receive information through the network 44. In embodiments of the present invention, I/O interface 32 comprises a modem, although I/O interface 32 may comprise other devices such as an Ethernet® network interface or an interface for receiving wireless network signals. Additionally, I/O interface 32 may comprise one or more data ports that may be coupled to an external data source (e.g., floppy disk drive, CD-ROM drive, audio input source, video input source, etc.), although the interface 32 may also comprise one or more devices that may read the types of fixed or portable computer-readable mediums described above with respect to memory 16.

Server 40 comprises one or more computer systems, such as a Vax or Apache system operating VMS or UNIX operating system (“OS”) platforms, for example, each having one or more processors, memory and I/O units coupled together by one or more buses, although other coupling techniques may be used. Moreover, server 40 may comprise any type of device or system that can store, process and execute instructions, or any device with circuitry that is hard-wired to execute instructions, for performing one or more methods of the present invention as described and illustrated herein. Since server systems are well known in the art, the specific elements, their arrangement within the server system and basic operation will not be described in detail here.

Computers 42 comprise client systems including personal desktop systems, such as IBM PC's, SUN Microsystems® or Macintosh® systems operating Microsoft Windows®, SunOS® or Macintosh® OS platforms, for example, each having one or more processors, memory units and I/O units coupled together by one or more buses. Moreover, computers 42 may comprise any type of device or system that can store, process and execute instructions, or any device with circuitry that is hard-wired to execute instructions, for performing one or more methods of the present invention as described and illustrated herein. Since computers are well known in the art, the specific elements, their arrangement within the computer and basic operation will not be described in detail here.

Network 44 comprises a public network such as the Internet, which may include one or more local area networks (“LANs”), wide area networks (“WANs”), telephone line networks, coaxial cable networks, wireless networks, or other public or private networks, such as a proprietary organizational network spread out over several geographical locations.

The operation of the system 10 for creating animated books in accordance with embodiments of the present invention will now be described with reference to FIGS. 2-5. Referring to FIGS. 2-3 and beginning at step 100, a user P sits down on the chair Ch within the booth 101. The booth 101 detects that a user is present using a number of means such as motion sensors, processor 14 polling controllers 18-22 for user input, or processor 14 detecting signals received from the vending unit 28 indicating that the user P has made a complete payment of a predetermined amount. Once the device 12 detects a presence, audio output controller 26 retrieves an initial greeting from the memory 16 and plays the greeting through speakers 102. In embodiments of the present invention, the greeting may welcome the user P and provide instructions on how to proceed along through steps 200-900 as described further herein.

Next at step 200, if the user P has not made a payment, then they may make a payment by inserting currency in vending unit interface 202. The vending unit 28 detects a payment was made, and determines whether the payment is complete (i.e., whether the predetermined amount of payment has been received).

Next at step 300, the processor 14 retrieves from memory 16 available templates for use in creating animated book 904. These templates may represent simple backgrounds that will be ultimately printed on each page of the animated book 904 and may be stored in memory 16 in a number of formats (i.e., .jpg, gif, etc.). Alternatively, the templates may include movie sequences stored in memory 16 in a number of video file formats. The processor 14 may control the display controller 24 to display a number of control menus on the display 302. The user P may enter their selections using the keyboard interface 402, and the input controller 20 may instruct the processor 14 as to which selections the user P has made with respect to the displayed menus. Depending upon the input received by the input controller 20, the templates are retrieved from the memory 16 by the display controller 24 and shown to the user P on the display 302.

Next at step 400, the user P makes their selections with respect to a template they would like to use. Processor 14 stores the selection in memory 16 for later processing as described further herein below.

Next at decision box 450, the processor 14 continues to poll input controller 20 for additional template selections. If the user P does not indicate being finished with their selections, the NO branch is followed and the processor 14 continues to poll for additional user template selections. But if the user P indicates their template selections are complete, the YES branch is followed.

Next at step 500, the user P may begin to record their animated message that will be used to compose the animated book 904. The user P may close the curtain Cu to prevent ambient light from interfering with the video capture.

When the user P is ready, they may use the keyboard interface 402 to begin the video capture, which sends a signal to processor 14 and in turn causes the processor 14 to control the video capture controller 18, although other techniques for initiating video capture can be used. The video capture controller 18 operates a video capture device aimed towards the user P to begin recording video through the lens 502. The video capture may take place for a predetermined amount of time (e.g., ten seconds), the amount of time depending upon memory constraints, the amount of payment made through the vending unit 28, or the desired or maximum size of the animated book 904.

Additionally, the user P may type in a personal message using the keyboard interface 402. This message may include a simple, personal message that will be reproduced in either an animated fashion or statically on each of the pages of the animated book 904. Further, the user P may include audio messages that would be received by a microphone 504 and processed by the audio input controller 22. In this example, the processor 14 may include programming for converting the received audio into textual data that may be stored in memory 16 for further processing as described herein. If the user P desires to view the animated book 904 before it is printed, they may access and select appropriate menu selections displayed on the display 302 to replay the captured video segment of themselves P′ on the display 302.

Next at step 600, the video capture is complete and the video data is stored in memory 16 in the appropriate video file format (e.g., avi, MPEG, QuickTime, etc.). The processor 14 parses the video data to separate the video data into separate stills, for example, which may be saved as separate image files. Each separate image file represents a portion of the recorded video data at an instant of time within a time interval (e.g., the duration of the video capture). Each of these images may be stored in memory 16 as separate graphical files (e.g., gif, jpg, etc.).

Processor 14 determines the number of pages that will be required to compose the animated book 904 based upon the total number of separate image files created by parsing the video data. Processor 14 then retrieves the selected template from memory 16 and merges the background graphical information with the separate images, so that each page of the animated book 904 will have one image merged with the selected template background. At this time, the processor 16 retrieves any textual data stored in memory 16 representing simple messages intended to be conveyed by the user as entered through the keyboard interface 402 or the microphone 504, and merges the textual message into each separate image.

As described above in connection with step 500, the user P may desire to view the animated book 904 before it is actually printed. Accordingly, the user P using keyboard interface 402 may indicate their desire to replay each of the combined image data files (e.g., separate images, textual messages, background graphic data, etc.) in succession to simulate the appearance of animation that will be created by flipping the pages of the animated book 904 once it is created as will be described further herein at step 800. If the user is not satisfied with the image data, they may repeat steps 300-600.

Next at step 700, processor 14 sends the combined template and image data to the book creation system 30, which prints each combination of the template and image data on each page of the animated book 904.

Next at step 800, the book creation system 30 binds the printed pages together at an end or along another portion of each page to create the animated book 904 with sheets of paper 906-1 through 906-n. As shown in FIG. 5, movement of a first bound sheet 906-2 in a first direction away from a second bound sheet 906-3 creates an appearance of motion of at least one portion H1 of one of the reproduced images P″ on the first sheet 906-2 with respect to at least one corresponding portion H2 of one of the reproduced images P″ on the second bound sheet 906-3.

Next at step 900, the booth 101 dispenses the completed animated book 904, which may be collected by the user P at the book pick-up interface 902.

An alternative method for creating animated books will now be described in accordance with embodiments of the present invention. In this embodiment, steps 100-500 are performed in the same manner described above, except the computers 42 perform at least a portion of the functions described in connection therewith. In particular, a user at one of the computers 42 may access the book creation device 12 through the network 44. In embodiments of the present invention, the computer 42 may access the device 12 either directly through network 44 or by way of server 40 and network 44. In embodiments where the computers 42 access the device 12 by way of server 40, the server 40 may be programmed to perform the functions described above in connection with steps 100-500 except as described herein below.

In either case, the computer 42 displays appropriate user interfaces, such as in the form of Web pages, plays an initial greeting as described in step 100 and accepts payment as described in step 200, except the payment may be made securely using payment verification software running on the computer 42 or server 40, for example. Further, the computer 42 receives the available templates from the server 40 or from memory 16 in the device 12, and displays the templates on a display of the computer 42 in the same manner described in connection with step 300. Thereafter, steps 400-500 are performed by the device 12 in the same manner described above, except the templates are displayed on a display of the computer 42 and the user makes their selections using an input device (e.g., keyboard, mouse, etc.) of the computer 42.

Further, at step 500, a user at the computer 42 may record their animated message using a video capture device, such as a video camera, which is interfaced with the computer 42, although the computer 42 user may select a video file already stored in the computer memory or elsewhere, such as the server 40. Once the animated message is recorded by the user, it is stored in the computer 42 memory at step 600. Thereafter, device 12 performs steps 600-900 in the same manner as described above, except the user may need to travel to pick up the animated book 904 at a location of the book creation device 12, unless the computer 42 is equipped with a book creation system 30 or other device (e.g., printer) to create the book 904.

Alternatively, the computer 42 user may specify, using user interfaces displayed by the computer 42, that the animated book 904 be sent electronically to one or more other devices, such as one or more other computers 42 and/or the server. In this example, the user would need to specify a destination location, such as an e-mail address. The computer 42 may instead specify a physical location, such as a postal address, for sending a printed and bound hardcopy of the animated book 904 to. Personnel at the device 12 may send the hardcopy animated book 904 to the desired destination via a courier service, for example.

Other modifications of the present invention may occur to those skilled in the art subsequent to a review of the present application, and these modifications, including equivalents thereof, are intended to be included within the scope of the present invention. Further, the recited order of processing elements or sequences, or the use of numbers, letters, or other designations therefor, is not intended to limit the claimed processes to any order except as may be specified in the claims.

What is claimed is:

1. A system comprising:
a converting system that converts video data into at least two images, each image representing a portion of the video data at an instant within a time interval;
a printing system that reproduces one of the images onto one of a plurality of sheets, the printing system reproducing another one of the images onto another one of the sheets; and
a binding system that binds a portion of each of the sheets together.

2. The system as set forth in claim 1 wherein the printing system prints each image onto a planar surface of each sheet.

3. The system as set forth in claim 1 wherein the printing system prints a selected background template image on each sheet.

4. The system as set forth in claim 1 further comprising a vending system that authorizes operation of at least one of the converting system, the printing system and the binding system upon receiving a signal indicating that a payment was made.

5. The system as set forth in claim 1 further comprising an input system that receives the video data from at least one source.

6. The system as set forth in claim 5 wherein the at least one source comprises at least one of a video camera, microphone, a server system and a client system.

7. The system as set forth in claim 1 wherein the converting system, the printing system and the binding system are arranged within a booth structure having at least one of a user input interface and a user output interface.

8. A method comprising:
converting video data into at least two images, each image representing a portion of the video data at an instant within a time interval;
reproducing one of the images onto one of a plurality of sheets;
reproducing another one of the images onto another one of the sheets; and
binding a portion of each of the sheets together.

9. The method as set forth in claim 8 wherein reproducing one of the images and reproducing another one of the images further comprises printing each image onto a planar surface of each sheet.

10. The method as set forth in claim 8 wherein reproducing one of the images and reproducing another one of the images further comprises printing a selected background image template on each sheet.

11. The method as set forth in claim 8 further comprising authorizing at least one of the converting, the reproducing and the connecting upon receiving a signal indicating that a payment was made.

12. The method as set forth in claim 8 further comprising receiving the video data from at least one source.

13. The method as set forth in claim 12 wherein the at least one source comprises at least one of a video camera, microphone, a server system and a client system.

14. A computer-readable medium having stored thereon instructions, which when executed by at least one processor, causes the processor to perform:
converting video data into at least two images, each at least one image representing a portion of the video data at an instant within a time interval;
reproducing one of the images onto one of a plurality of sheets;
reproducing another one of the images onto another one of the sheets; and
binding a portion of each of the sheets together.

15. The medium as set forth in claim 14 wherein reproducing one of the images and reproducing another one of the images further comprises printing each image onto a planar surface of each sheet.

16. The medium as set forth in claim 14 wherein reproducing one of the images and reproducing another one of the images further comprises printing a selected background image template on each sheet.

17. The medium as set forth in claim 14 further comprising authorizing at least one of the converting, the reproducing and the connecting upon receiving a signal indicating that a payment was made.

18. The medium as set forth in claim 14 further comprising receiving the video data from at least one source.

19. The medium as set forth in claim 18 wherein the at least one source comprises at least one of a video camera, microphone, a server system and a client system.
